(19) United States
(12) Patent Application Publication
(10) Pub. No.: US 2024/0153032 A1
(43) Pub. Date: May 9, 2024

(54) TWO-DIMENSIONAL POSE ESTIMATIONS

(71) Applicant: Hinge Health, Inc., San Francisco, CA (US)

(72) Inventors: Caroline Rougier, Montreal (CA); Dong Wook Cho, Pierrefonds (CA)

(21) Appl. No.: 18/414,891

(22) Filed: Jan. 17, 2024

Related U.S. Application Data
(63) Continuation of application No. PCT/IB2021/056819, filed on Jul. 27, 2021.

(51) Int. Cl. G06T 3/4046; G06T 5/50

(52) U.S. Cl. CPC G06T 3/4046; G06T 5/50; G06T 2207/20221; G06T 2207/30196

(57) ABSTRACT

An apparatus is provided to estimate two-dimensional poses. The apparatus includes a communications interface to receive raw data. The raw data includes a representation of first and second objects. In addition, the apparatus includes a memory storage unit to store the raw data. Furthermore, the apparatus includes a neural network engine to apply a first convolution to the raw data to extract first features from a first output, to downsample the first output to extract a first set of subfeatures from a first suboutput, to apply a second convolution to the first output to extract a second set of features from a second output, and to apply the second convolution the first suboutput. The second output and the second suboutput are to be merged to generate joint heatmaps of the first object and the second object, and bone heatmaps of the first object and the second object.

### CROSS-REFERENCE TO RELATED APPLICATION(S)

This application is a continuation of International Patent Application No. PCT/IB2021/056819, titled “Two-Dimensional Pose Estimations” and filed on Jul. 27, 2021, which is incorporated herein by reference in its entirety.

### BACKGROUND

Object identifications in images may be used for multiple purposes. For example, objects may be identified in an image for use in other downstream application. In particular, the identification of an object may be used for tracking the object, such as a player on a sport field, to follow the player's motions and to capture the motions for subsequent playback or analysis.

The identification of objects in images and videos may be carried out with methods such as edge-based segmentation detection and other computer vision methods. Such methods may be used to separate objects, especially people, to estimate poses in two-dimensions for use in various applications, such as three-dimensional reconstruction, object-centric scene understanding, surveillance, and action recognition.

### BRIEF DESCRIPTION OF THE DRAWINGS

Reference will now be made, by way of example only, to the accompanying drawings in which:

FIG. 1 is a schematic representation of the components of an example apparatus to generate two-dimensional pose estimations from raw images with multiple objects;

FIG. 2 is a flowchart of an example of a method of generating two-dimensional pose estimations from raw images with multiple objects;

FIG. 3 is a schematic representation of an architecture for two-dimensional pose estimation;

FIG. 4 is an example of raw data representing an image received at the apparatus of FIG. 1;

FIG. 5 is a representation of a person in an A-pose to illustrate the joints and bones used by the apparatus of FIG. 1;

FIG. 6A is a joint heatmap of a combination of a plurality of predefined joints; and

FIG. 6B is an exemplary bone heatmap a bone connecting the neck and right hip.

### DETAILED DESCRIPTION

As used herein, any usage of terms that suggest an absolute orientation (e.g. “top”, “bottom”, “up”, “down”, “left”, “right”, “low”, “high”, etc.) may be for illustrative convenience and refer to the orientation shown in a particular figure. However, such terms are not to be construed in a limiting sense as it is contemplated that various components will, in practice, be utilized in orientations that are the same as, or different than those described or shown.

Object identifications in images may be used for multiple purposes. For example, objects may be identified in an image for use in other downstream application. In particular, the identification of an object may be used for tracking the object, such as a player on a sport field, to follow the player's motions and to capture the motions for subsequent playback or analysis.

The estimation of two-dimensional poses may be carried out using a convolutional neural network. Pose estimation may include the localizing of joints used to reconstruct a two-dimensional skeleton of an object in an image. The skeleton may be defined by joints and/or bones which may be determined using joint heatmaps and bone heatmaps. The architecture of the convolutional neural network is not particularly limited and the convolutional neural network may use a feature extractor to identify features in a raw image which may be used for further processing. For example, a feature extractor developed and trained by the Visual Geometry Group (VGG) can be used. While the VGG backbone may produce high quality data, the operation of the VGG feature extractor is heavy and slow.

In other examples, different architectures may be used. For example, a residual network (ResNet) architecture may also be used in some examples. As another example, a MobileNet architecture may also be used to improve speed at the cost of decreased accuracy.

An apparatus and method of using an efficient architecture for two-dimensional pose estimation is provided. As an example, the apparatus may be a backbone for feature extraction that use of mobile inverted bottleneck blocks. In the present example, features from different outputs may be gathered to improve multi-scale performance to detect objects at different depths of the two-dimensional raw image. In some examples, the apparatus may further implement a multi-stage refinement process to generate joints and bone maps for output.

In the present description, the models and techniques discussed below are generally applied to a person. It is to be appreciated by a person of skill with the benefit of this description that the examples described below may be applied to other objects as well such as animals and machines.

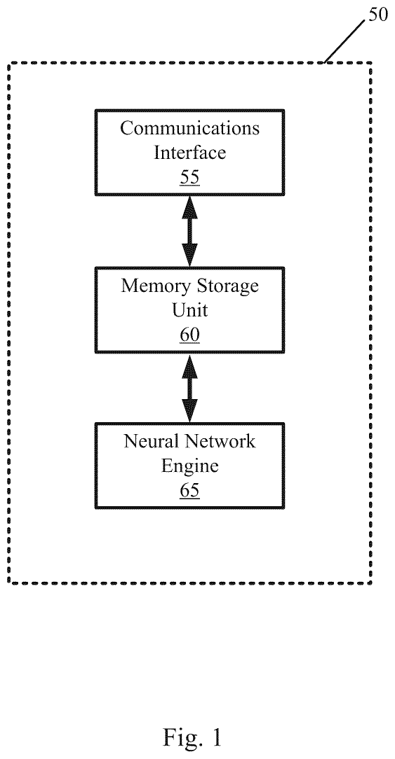

Referring to FIG. 1, a schematic representation of an apparatus to generate two-dimensional pose estimations from raw images with multiple objects is generally shown at 50. The apparatus 50 may include additional components, such as various additional interfaces and/or input/output devices such as indicators to interact with a user of the apparatus 50. The interactions may include viewing the operational status of the apparatus 50 or the system in which the apparatus 50 operates, updating parameters of the apparatus 50, or resetting the apparatus 50. In the present example, the apparatus 50 is to receive raw data, such as an image in RGB format, and to process the raw data to generate output that includes two-dimensional pose estimations of objects, such as people, in the raw data. The output is not particularly limited and may include a joint heatmap and/or a bone heatmap. In the present example, the apparatus 50 includes a communications interface 55, a memory storage unit 60, and a neural network engine 65.

The communications interface 55 is to communicate with an external source to receive raw data representing a plurality of objects in an image. Although the raw data representing the image is not particularly limited, it is to be appreciated that the apparatus 50 is generally configured to handle complex images with multiple objects, such as people, in different poses and different depths. In addition, the image may include objects that are partially occluded to complicate the identification of objects in the image. The occlusions are not limited and in some cases, the image may include many objects such that the objects occlude each other or itself. In other examples, the object may involve occlusions caused by other features for which a pose estimation is not made. In further examples, the object may involve occlusions caused by characteristics of the image, such as the border.

In the present example, the raw data may be a two-dimensional image of objects. The raw data may also be resized from an original image captured by a camera due to computational efficiencies or resources required for handling large images files. In the present example, the raw data may be an image file 456×256 pixels downsized from an original image of 1920×1080 pixels. The manner by which the objects are represented and the exact format of the two-dimensional image is not particularly limited. In the present example, the two-dimensional image may be received in an RGB format. It is to be appreciated by a person of skill in the art with the benefit of this description that the two-dimensional image be in a different format, such as a raster graphic file or a compressed image file captured and processed by a camera.

The manner by which the communications interface 55 receives the raw data is not limited. In the present example, the communications interface 55 communicates with external source over a network, which may be a public network shared with a large number of connected devices, such as a WiFi network or cellular network. In other examples, the communications interface 55 may receive data from an external source via a private network, such as an intranet or a wired connection with other devices. In addition, the external source from which the communications interface 55 receives the raw data is not limited to any type of source. For example, the communications interface 55 may connect to another proximate portable electronic device capturing the raw data via a Bluetooth connection, radio signals, or infrared signals. As another example, the communications interface 55 is to receive raw data from a camera system or an external data source, such as the cloud. The raw data received via the communications interface 55 is generally to be stored on the memory storage unit 60.

In another example, the apparatus 50 may be part of a portable electronic device, such as a smartphone, that includes a camera system (not shown) to capture the raw data. Accordingly, in this example, the communications interface 55 may include the electrical connections within the portable electronic device to connect the apparatus 50 portion of the portable electronic device with the camera system. The electrical connections may include various internal buses within the portable electronic device.

Furthermore, the communications interface 55 may be used to transmit results, such joint heatmaps and/or bone heatmaps that may be used to estimate the pose of the objects in the original image. Accordingly, the apparatus 50 may operate to receive raw data from an external source representing multiple objects with complex occlusions where two-dimensional poses are to be estimated. The apparatus 50 may subsequently provide the output to the same external source or transmit the output to another device for downstream processing.

The memory storage unit 60 is to store the raw data received via the communications interface 55. In particular, the memory storage unit 60 may store raw data including two-dimensional images representing multiple objects with complex occlusions for which a pose is to be estimated. In the present example, the memory storage unit 60 may store a series of two-dimensional images to form a video. Accordingly, the raw data may be video data representing movement of various objects in the image. As a specific example, the objects may be images of people having different sizes and may include the people in different poses showing different joints and having some portions of the body occlude other joints and portions of the body. For example, the image may be of sport scene where multiple players are captured moving about in normal game play. It is to be appreciated by a person of skill that in such a scene, each player may occlude another player. In addition, other objects, such as a game piece or arena fixture may further occlude the players. Although the present examples relate to a two-dimensional image of one or more humans, it is to be appreciated with the benefit of this description that the examples may also include images that represent different types of objects, such as an animal or a machine that may be in various poses. For example, the image may represent an image capture of a grassland scene with multiple animals moving about or of a construction site where multiple pieces of equipment may be in different poses.

In addition to raw data, the memory storage unit 60 may also be used to store data to be used by the apparatus 50. For example, the memory storage unit 60 may store various reference data sources, such as templates and model data, to be used by the neural network engine 65. The memory storage unit 60 may also be used to store results from the neural network engine 65. In addition, the memory storage unit 60 may be used to store instructions for general operation of the apparatus 50. The memory storage unit 60 may also store an operating system that is executable by a processor to provide general functionality to the apparatus 50 such as functionality to support various applications. The memory storage unit 60 may additionally store instructions to operate the neural network engine 65 to carry out a method of two-dimensional pose estimation. Furthermore, the memory storage unit 60 may also store control instructions to operate other components and any peripheral devices that may be installed with the apparatus 50, such cameras and user interfaces.

In the present example, the memory storage unit 60 is not particularly limited and may include a non-transitory machine-readable storage medium that may be any electronic, magnetic, optical, or other physical storage device. The memory storage unit 60 may be preloaded with data or instructions to operate components of the apparatus 50. In other examples, the instructions may be loaded via the communications interface 55 or by directly transferring the instructions from a portable memory storage device connected to the apparatus 50, such as a memory flash drive. In other examples, the memory storage unit 60 may be an external unit such as an external hard drive, or a cloud service providing content.

The neural network engine 65 is to receive or retrieve the raw data stored in the memory storage unit 60. In the present example, the neural network engine 65 applies an initial series of inverted residual blocks to the raw data to extract a set of features. The initial series of inverted residual blocks is not particularly limited and may be any convolution capable of extracting low level features such as edges in the image. In particular, the initial convolution may be carried out on the initial STEM outputs to extract low level features such as edges in the image. In the present example, the initial convolution involves applying a 3×3 filter to carry out a strided convolution with a stride of two to the raw data image. Accordingly, the raw data will be downsampled to generate output with a lower resolution. In the present example, a raw data image may include an image with a resolution of 456×256 pixels and downsampled to a 228×128 pixel image. It is to be appreciated that a set of features may be extracted from this image, such as low level features.

In other examples, it is to be understood that the parameters may be modified. For example, the initial convolution may involve applying a 5×5 filter to carry out a strided convolution with a stride of two to the raw data image. Other filters may also be used, such as a 7×7 filter. Furthermore, although a strided convolution is used in the present example to downsample, it is to be appreciated by a person of skill that other methods of downsampling may also be used such as applying a 2×2 pooling operation with a stride of two.

The neural network engine 65 further processes the data by continuing to apply a series filters in subsequent outputs. In the present example, the neural network engine 65 further downsamples the output generated by the initial convolution to generate a suboutput from which subfeatures may be extracted. The downsampling of the output generated by the initial convolution is not particularly limited and may include a strided convolution operation or a pooling operation. The pooling operation may be a maximum pooling operation applied to the output in some examples. In other examples, an average pooling operation may be applied to downsample the output. In the present example, the output may provide for the detection of subfeatures which are larger features than those detected in the main output.

Subsequently, the neural network engine 65 applies a series of inverted residual blocks to both the output and the suboutput. The convolution is to be applied separate to the output and the suboutput to generate another output and suboutput, respectively. The output generated by the subsequent convolution may include additional mid-level features.

A series of inverted residual blocks, such as a mobile inverted bottleneck, is applied for both the main branch and the sub branch. The architecture of an inverted residual block involves three general steps. First, the data is expanded to generate a high-dimensional representation of the data by increasing the number of channels. The input into the network may be represented by a matrix with three dimensions representing the width of the image, the height of the image and channel dimension, which represents the colors of the image. Continuing with the example above of an image of 456×256 pixels in RGB format, the input may be represented by a 456×256×3 matrix. By applying a strided 3×3 convolution with 64 filters, the matrix will be 228×128×64. The number of channels will increase accordingly at each subsequent output. The expanded data is then filtered with a depthwise convolution to remove redundant information. The depthwise convolution may be a lightweight convolution that may be efficiently carried out on a device with limited computation computational resources, such as a mobile device. The features extracted during the depthwise convolution may be projected back to a low-dimensional representation using a linear convolution, such as a 1×1 convolution, with a reduced number of filters which may be different from the original channel numbers.

It is to be appreciated by a person of skill in the art that the neural network engine 65 may apply additional convolutions subsequent outputs in an iterative manner to extract additional features. In the present example, the process is iterated three times. However, in other examples, the process may be iterated fewer times or more times.

Upon generation of the final output and suboutput, the neural network engine 65 merges the output and suboutput. The manner by which the output and suboutput is merged is not limited and may involve adding or concatenating the matrices representing each output. It is to be appreciated by a person of skill with the benefit of this description that the suboutput has a lower resolution than the output due to the initial downsampling from the initial convolution. Accordingly, the suboutput is to be upsampled to the same resolution as the final output. The manner by which the suboutput is upsampled is not particularly limited and may include a deconvolution operation, such as learnt upsampling, or an upsampling operation, such as nearest neighbor or bilinear followed by a convolution. Alternatively, the output may be downsampled to the same resolution as the suboutput. The manner by which the output is downsampled is not particularly limited and may include a pooling operation or a strided convolution. For example, the pooling operation may include a maximum pooling or average pooling process.

Using the merged outputs from the backbone, the neural network engine 65 generates joint heatmaps and bone heatmaps for each of the objects in the original raw image data. The heatmaps may be obtained with a regression network containing multiple stages for refinement. Each stage may include a succession of residual outputs to regress the predicted heatmaps using the ground truth heatmaps. In the present example, the regression network includes three stages 350, 360, and 370 to generate heatmaps 380 for outputting to downstream services. In other examples, one, two or more stages may also be used to refine the predicted heatmaps.

The heatmaps may be provided as output from the apparatus 50 to be used to generate skeletons or other representations of the pose of the object. In addition, the heatmaps may be used for other object operations, such as segmentation or three-dimension pose estimation.

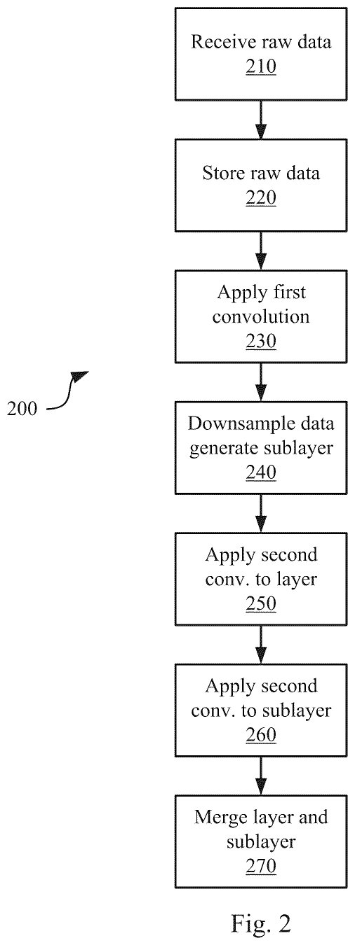

Referring to FIG. 2, a flowchart of an example method of generating two-dimensional pose estimations from raw images with multiple objects is shown at 200. In order to assist in the explanation of method 200, it will be assumed that method 200 may be performed by the apparatus 50. Indeed, the method 200 may be one way in which the apparatus 50 may be configured. Furthermore, the following discussion of method 200 may lead to a further understanding of the apparatus 50 and its components. In addition, it is to be emphasized, that method 200 may not be performed in the exact sequence as shown, and various blocks may be performed in parallel rather than in sequence, or in a different sequence altogether.

Beginning at block 210, the apparatus 50 receives raw data from an external source via the communications interface 55. In the present example, the raw data includes a representation of multiple objects in an image. In the present example, the raw data represents multiple humans in various poses, who may also be at different depths. The manner by which the objects are represented and the exact format of the two-dimensional image is not particularly limited. For example, the two-dimensional image is received in an RGB format. In other examples, the two-dimensional image be in a different format, such as a raster graphic file or a compressed image file captured and processed by a camera. Once received at the apparatus 50, the raw data is to be stored in the memory storage unit 60 at block 220.

Next, the neural network engine 65 the carries out blocks 230 to 270. Block 230 applies an initial convolution referred to as a the initial STEM output. In the present example, the initial convolution involves applying a 3×3 filter to carry out a strided convolution with a stride of two to the raw data image to generate downsampled data to form an output with lower resolution than the raw data. This output may be used to extract features from the raw data, such as low level features which may include edges.

Block 240 downsamples the output generated at block 230 to generate a suboutput from which subfeatures may be extracted. The downsampling is carried out via a deconvolution operation or a pooling operation. In particular, the present example applies a maximum pooling operation to the output generated at block 230. It is to be appreciated by a person of skill with the benefit of this description that the output generated by block 230 and the suboutput generated by block 240 forms a multi-branch backbone to be processed. In the present example, two branches are used. In other examples, more branches may be formed.

Blocks 250 and 260 apply a convolution to the output generated at block 230 and the suboutput generated at block 240, respectively. In particular, blocks 250 and 260 apply an inverted residual block, such as a mobile inverted bottleneck to the output generated at block 230 and the suboutput generated at block 240, respectively. The resulting output and suboutput may include additional features and subfeatures which may be extracted. In the present example, the neural network engine 65 may apply additional convolutions subsequent outputs and suboutputs in an iterative manner to extract additional features. It is to be appreciated that the data in the outputs form one branch of convolutions beginning with the output generated at block 230. The suboutputs form another branch of convolutions beginning with the suboutput generated at block 240. In this example, the outputs and suboutputs are merged at each iteration via an upsampling process or downsampling process.

After a predetermined number of iterations is carried out, block 270 merges the output and suboutput. The manner by which the output and suboutput is merged is not limited and may involve adding the matrices representing each output. It is to be appreciated by a person of skill with the benefit of this description that the suboutput generated at block 240 has a lower resolution than the output generated at block 230 due to the initial downsampling at block 240. Since the resolution in the two branches are maintained, the suboutput is to be upsampled to the same resolution as the output in the first branch. The manner by which the suboutput is upsampled is not particularly limited and may include a deconvolution operation. Alternatively, the output in the first branch may be downsampled to the same resolution as the suboutput. The merged data may then be used to generate joint heatmaps and bone heatmaps for each of the objects in the original raw image data.

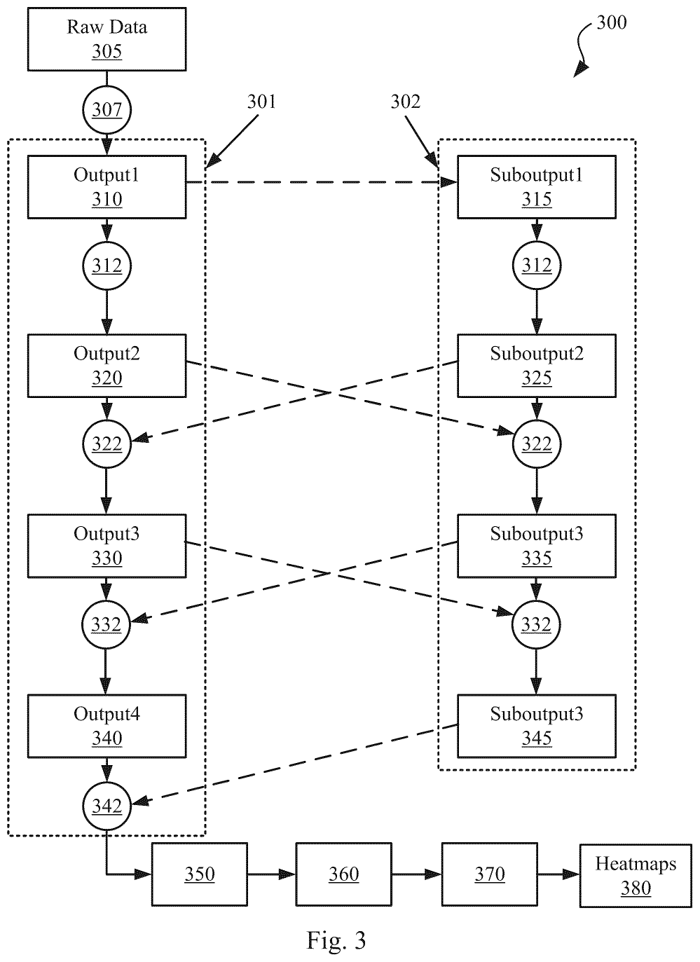

Referring to FIG. 3, a flowchart of an example architecture 300 to generate two-dimensional pose estimations from a raw image with multiple objects is shown. In order to assist in the explanation of architecture 300, it will be assumed it is executed by the neural network engine 65. The following discussion of architecture 300 may lead to a further understanding of the operation of the neural network engine 65.

In the present example, raw data 305 is received by the neural network engine 65. The neural network engine 65 applies a convolution 307 to the raw data 305. In this example, the convolution 307 involves applying a 3×3 filter to carry out a strided convolution with a stride of two to the raw data 305 to generate downsampled data to form a output 310 with lower resolution than the raw data 305. The data output 310 is then further downsampled using a maximum pooling operation to generate a suboutput 315. It is to be appreciated by a person of skill with the benefit of this description that the data output 310 is the start of a high resolution branch 301 for processing and the data suboutput 315 is the start of a low resolution branch 302 for processing.

The neural network engine 65 then applies the first series of inverted residual blocks 312 to the data output 310 to generate the data output 320. In addition, the neural network engine 65 also applies the first series of inverted residual blocks 312 to the data suboutput 315 to generate the data suboutput 325. The data suboutput 325 is then upsampled and merged with the data output 320. Another series of inverted residual blocks 322 is applied to the merged data in the high resolution branch 301 to generate the next data output 330. Similarly, the data output 320 is downsampled and merged with the data suboutput 325 in the low resolution branch 302. The series of inverted residual blocks 322 is applied to this merged data in the low resolution branch 302 branch to generate the next data output 335. In the present example, the process is repeated with inverted residual blocks 332 to generate the data output 340 and the data suboutput 345.

In the present example, the data output 340 and the data suboutput 345 is the final iteration and the data suboutput 345 is upsampled and merged with the data output 340 applying the inverted residual convolution 342.

It is to be appreciated by a person of skill with the benefit of this description that variations are contemplated. For example, instead of upsampling and downsampling for each output and suboutput, the branches 301 and 302 may continue processing independently until the end when they are merged.

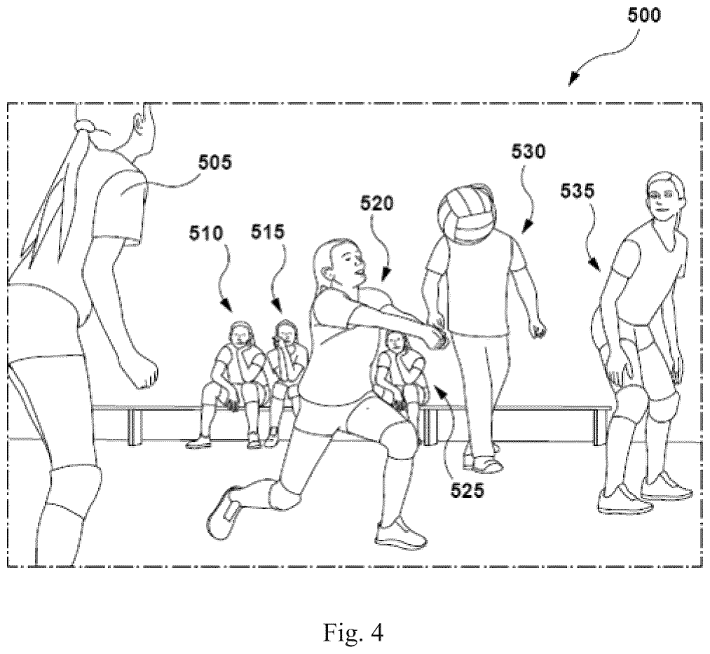

Referring to FIG. 4, an example of an image 500 represented by raw data is generally shown. In the present example, the objects in the raw image are people. The image 500 is a sport scene with multiple objects 505, 510, 515, 520, 525, 530, and 535. The object 505 is shown to be close to the camera and the objects 510, 515, and 525 are further away and thus appear smaller in the two-dimensional image. Furthermore, the object 530 is partially obstructed by a non-target object, the ball.

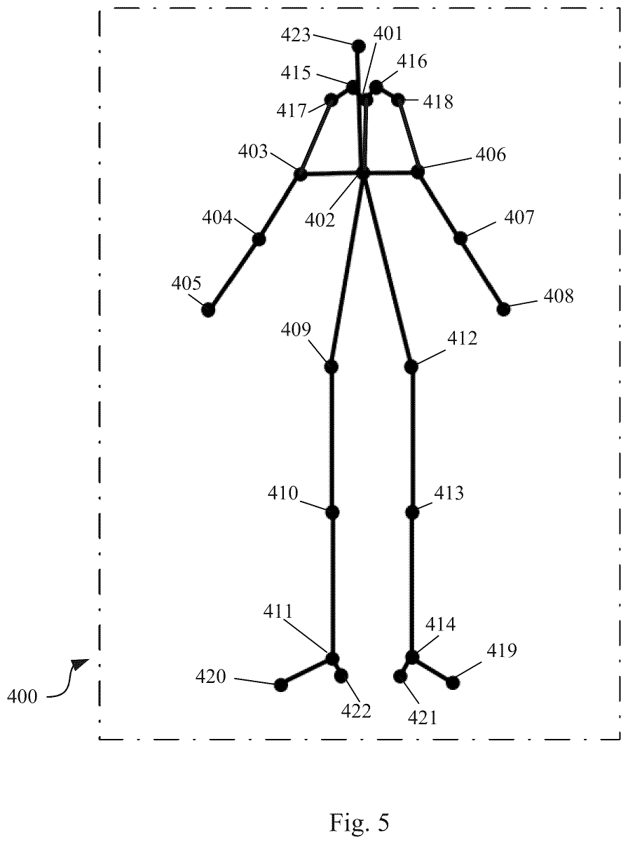

In the present example, the apparatus 50 is configured to identify and generate heatmaps for twenty-three predefined joints. It is to be appreciated by a person of skill with the benefit of this description that the number of joints is not particularly limited. For example, the apparatus 50 may be configured to generate heatmaps for more joints or fewer joints depending on the target resolution as well as the computational resources available. Referring to FIG. 5, an illustration of the predetermined joints and bones for a person in an A-pose in the present example is shown at 400. In the present example, the joints are listed in Table 1 below.

TABLE 1

| Reference | |
|---|---|
| Character | Joint Name |
| 401 | Nose |
| 402 | Neck |
| 403 | Right Shoulder |
| 404 | Right Elbow |
| 405 | Right Wrist |
| 406 | Left Shoulder |
| 407 | Left Elbow |
| 408 | Left Wrist |
| 409 | Right Hip |
| 410 | Right Knee |
| 411 | Right Ankle |
| 412 | Left Hip |
| 413 | Left Knee |
| 414 | Left Ankle |
| 415 | Right Eye |
| 416 | Left Eye |
| 417 | Right Ear |
| 418 | Left Ear |
| 419 | Left Toe |
| 420 | Right Toe |
| 421 | Left Heel |
| 422 | Right Heel |
| 423 | Head Top |

Furthermore, a bone structure may be predetermined as well. In this example, bones may be defined to connect two joints. Accordingly bone heatmaps may also be generated for each predefined bone. In the present example, separate heatmaps are generated for the x-direction and the y-direction for each bone. Since the bone connects two joints, the magnitude in the heatmaps correspond to a probability of a bone in a the x-direction or the y-directions. For example, the bone connecting the neck 402 to the right shoulder 403 will have a high value in the x-direction bone heatmap and have a low values in the y-direction bone heatmap for a standing person. As another example, the bone connecting the right hip 409 to the right knee 410 will have a high value in the y-direction bone heatmap and have a low values in the x-direction bone heatmap for a standing person. In the present example, there are 48 bone heatmaps that are predefined. In particular, there are 24 pairs of joint connections where each pair includes an x-direction heatmap and a y-direction heatmap. In the present example, the predefined bones are listed in Table 2 below.

TABLE 2
Bone

Neck 402 to Right Hip 409
Right Hip 409 to Right Knee 410
Right Knee 410 to Right Ankle 411
Neck 402 to Left Hip 412
Left Hip 412 to Left Knee 413
Left Knee 413 to Left Ankle 414
Neck 402 to Right Shoulder 403
Right Shoulder 403 to Right Elbow 404
Right Elbow 404 to Right Wrist 405
Right Shoulder 403 to Right Ear 417
Neck 402 to Left Shoulder 406
Left Shoulder 406 to Left Elbow 407
Left Elbow 407 to Left Wrist 408
Left Shoulder 406 to Left Ear 418
Neck 402 to Nose 401
Nose 401 to Right Eye 415
Nose 401 to Left Eye 416
Right Eye 415 to Right Ear 417
Left Eye 416 to Left Ear 418
Left Ankle 414 to Left Toe 419
Right Ankle 411 to Right Toe 420
Left Ankle 414 to Left Heel 421
Right Ankle 411 to Right Heel 422
Neck 402 to Head Top 423

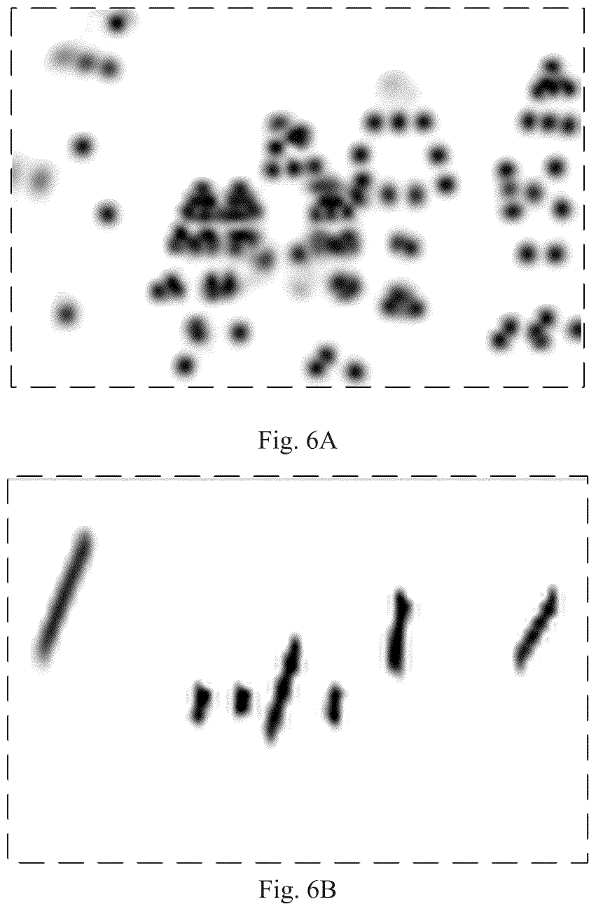

Once the apparatus 50 processes the raw data image 500, joint heatmaps and bone heatmaps may be generated. In the present example, it is to be appreciated with the benefit of this description that the joint heatmaps may be combined to generate a representation of the joints as shown in FIG. 6A. The manner by which the joint heatmaps are combined is not limited and may be a sum of the joint heatmaps provided by the apparatus 50 when overlaid on top of each other. Referring to FIG. 6B, a bone heatmap of the bone between the neck 402 and the right hip 409 for the y-direction is shown. Since the bone heatmaps provided by the apparatus 50 includes more complicated maps, overlaying multiple bone heatmaps may not generate a useful combination as for illustrative purposes. Accordingly, a single bone heatmap is shown out of the 48 bone heatmaps in FIG. 6B.

After generating the heatmaps, it is to be appreciated by a person of skill with the benefit of this description that the heatmaps may be used to generate skeletons to represent people in a two-dimensional image. The manner by which skeletons are generated is not particularly limited, and may include searching for peak maximums in the heatmaps and clustering joint locations.

Various advantages will now become apparent to a person of skill in the art. In particular, the apparatus 50 provides an architecture to determine two-dimensional pose estimation in a computationally efficient manner. In particular, the architecture has been demonstrated on computational resources limited devices, such as a portable electronic device like a smartphone. The multi-branch approach further improves the accuracy of the two-dimensional pose estimations. Therefore, the apparatus 50 estimates two-dimensional poses robustly with less computational load facilitating higher frame rates or lighter hardware and be useful to build real time systems that includes vision based human pose estimation.

It should be recognized that features and aspects of the various examples provided above may be combined into further examples that also fall within the scope of the present disclosure.

What is claimed is:

1. An apparatus comprising:
a communications interface to receive raw data from an external source, wherein the raw data includes a representation of a first object and a second object;
a memory storage unit to store the raw data; and
a neural network engine to apply a first convolution to the raw data to extract first features from a first output, to downsample the first output to extract a first set of subfeatures from a first suboutput, to apply a second convolution to the first output to extract a second set of features from a second output, and to apply the second convolution to the first suboutput to extract a second set of subfeatures from a second suboutput,
wherein the second output and the second suboutput are merged to generate joint heatmaps of the first object and the second object, and bone heatmaps of the first object and the second object.

2. The apparatus of claim 1, wherein the second suboutput is upsampled and merged with the second output to generate a first merged output.

3. The apparatus of claim 2, wherein the second output is downsampled and merged with the second suboutput to generate a first merged suboutput.

4. The apparatus of claim 3, wherein the neural network engine is to apply a third convolution the first merged output to generate a third output, and to apply the third convolution the first merged suboutput to generate a third suboutput.

5. The apparatus of claim 1, wherein the first features are low level features.

6. The apparatus of claim 5, wherein the low level features are edges.

7. The apparatus of claim 1, wherein neural network engine downsamples with a maximum pooling operation.

8. The apparatus of claim 1, wherein neural network engine upsamples with a deconvolution operation.

9. A method comprising:
receiving raw data from an image source via a communications interface, wherein the raw data includes a representation of a first object and a second object;
storing the raw data in a memory storage unit;
applying a first convolution to the raw data to extract first features from a first output;
downsampling the first output to extract a first set of subfeatures from a first suboutput;
applying a second convolution to the first output to extract a second set of features from a second output;
applying the second convolution the first suboutput to extract a second set of subfeatures from a second suboutput; and
merging the second output and the second suboutput to generate joint heatmaps of the first object and the second object, bone heatmaps of the first object and the second object.

10. The method of claim 9, further comprising upsampling and merging the second suboutput with the second output to generate a first merged output.

11. The method of claim 10, further comprising downsampling and merging the second output with the second suboutput to generate a first merged suboutput.

12. The method of claim 11, further comprising applying a third convolution to the first merged output to generate a third output, and applying the third convolution the first merged suboutput to generate a third suboutput.

13. The method of claim 9, wherein applying a first convolution comprises downsampling the raw data to extract low level features.

14. The method of claim 13, wherein the low level features are edges.

15. The method of claim 9, wherein downsampling comprises execute a maximum pooling operation.

16. The method of claim 9, wherein upsampling comprises apply a deconvolution operation.

17. A non-transitory computer readable medium encoded with codes, wherein the codes are to direct a processor to:
receive raw data from an image source via a communications interface, wherein the raw data includes a representation of a first object and a second object;
store the raw data in a memory storage unit;
apply a first convolution to the raw data to extract first features from a first output;
downsample the first output to extract a first set of subfeatures from a first suboutput;
apply a second convolution to the first output to extract a second set of features from a second output;
apply the second convolution the first suboutput to extract a second set of subfeatures from a second suboutput; and
merge the second output and the second suboutput to generate joint heatmaps of the first object and the second object, bone heatmaps of the first object and the second object.

18. The non-transitory computer readable medium of claim 17, wherein the codes are to direct the processor to upsample the second suboutput and to merge the second suboutput with the second output to generate a first merged output.

19. The non-transitory computer readable medium of claim 18, wherein the codes are to direct the processor to downsample the second output and to merge the second output with the second suboutput to generate a first merged suboutput.

20. The non-transitory computer readable medium of claim 19, wherein the codes are to direct the processor to apply a third convolution to the second merged output to generate a third output, and to apply the third convolution the first merged suboutput to generate a third suboutput.
